(19) United States
(12) Patent Application Publication
(10) Pub. No.: US 2026/0093990 A1
(43) Pub. Date: Apr. 2, 2026

(54) ALIGNMENT OF NEURAL NETWORKS USING ARCHITECTURAL MODIFICATIONS AND TRAINING EXAMPLES

(71) Applicant: GDM Holding LLC, Mountain View, CA (US)

(72) Inventors: Xiangyu Qi, Princeton, NJ (US); Xiao Ma, Seattle, WA (US); Ahmad Beirami, Broomfield, CO (US)

(21) Appl. No.: 19/346,875

(22) Filed: Oct. 1, 2025

Related U.S. Application Data
(60) Provisional application No. 63/702,110, filed on Oct. 1, 2024.

(51) Int. Cl. G06N 3/082; G06N 3/084

(52) U.S. Cl. CPC G06N 3/082; G06N 3/084

(57) ABSTRACT

Methods, systems, and apparatus, including computer programs encoded on a computer storage medium for aligning the output of a pre-trained generative neural network. In one aspect, the pre-trained generative neural network is adapted by introducing one or more filter layers. Each filter layer processes a filter layer input comprising an output from a stack of the pre-trained neural network layers, in accordance with trainable parameters of the filter layer, to generate a filter layer output. A next neural network layer after the stack of pre-trained neural network layers is configured to process at least the filter layer output. The trainable parameters of the filter layer(s) are adjusted using a training objective to increase the likelihood of the adapted neural network generating aligned responses to a plurality of training requests, whilst keeping pre-trained trainable parameters of the pre-trained neural network layers fixed.

### CROSS-REFERENCE TO RELATED APPLICATION

This application claims priority under 35 U.S.C. 119 to Provisional Application No. 63/702,110, filed Oct. 1, 2024, which is incorporated by reference.

### BACKGROUND

This specification relates to generating data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes methods and systems, implemented as computer programs on one or more computers in one or more locations, for alignment of the output of a pre-trained generative neural network, e.g. based on training examples.

Implementations of the techniques can be used for alignment of the output, i.e. adaption of a distribution of the generated outputs, for safety or other purposes. The output of the neural network is aligned by modifying the architecture of a pre-trained generative neural network, and in some aspects, based on training examples that are intended to provoke dispreferred outputs, e.g. outputs that are considered unsafe or otherwise unfit for the intended purpose. Implementations of the technique are adapted for use in a parallel processing computing system.

In one aspect there is described a computer-implemented method of alignment, i.e. adapting the distribution of, the output of a pre-trained neural network using a dataset of training examples. Typically, the pre-trained neural network is a generative neural network and the training examples can comprise requests, i.e. training requests, such as queries, for which the pre-trained neural network has been trained to generate responses.

The pre-trained neural network comprises a plurality of pre-trained neural network layers each having a plurality of pre-trained trainable parameters. The method involves modifying the pre-trained neural network to add one or more filter layers, and adjusting the values of trainable parameters, such as weights, of just the filter layers whilst training on the training examples. As described later, implementations of the technique are particularly adapted to parallel processing.

In implementations of the technique, the pre-trained neural network comprises a (large) language model (LLM) or vision language model (VLM) neural network, in particular a so-called foundation model.

There is also described a method of using such a modified, and aligned, neural network to generate responses to requests.

There is further described a method of generating safe responses to requests, whether or not such a modified, and aligned, neural network is used.

There are also described computer systems to implement the methods, and corresponding computer program code.

The subject matter described in this specification can be implemented in particular embodiments so as to realize one or more of the following advantages.

The described techniques are particularly useful for safety alignment of a generative neural network model such as an LLM or VLM, although they can also be used for other types of alignment. When used for safety alignment the training examples can comprise “harmful” requests. In general, a harmful request can be one that is intended to elicit a harmful response, e.g. one that includes offensive or potentially dangerous content. While what counts as harmful can be subjective, it can effectively be defined by a distribution of the training examples.

One difficulty with existing techniques for safety alignment is that they are vulnerable to so-called jailbreaking, where a harmful request, e.g. one preceded by a carefully chosen prompt can, elicit a harmful response even when the model has been trained not to provide such a response. Nonetheless, it appears that even when a model has been jailbroken, its latent representations often still contain signals indicating that the content was harmful.

Implementations of the described techniques take advantage of these signals to regulate the behavior of the model more effectively. Surprisingly, it has been found that by adding one or more filter neural network layers within the architecture of the model, and then training just these layers to reduce the risk of the model generating harmful responses, the risk of jailbreaking can be substantially reduced. It appears that this is because the filter neural network layers are able to see and use the latent representations.

The technique can be particularly effective when the model is trained by appending part of a harmful response to the end of a harmful query. This helps the model, and in particular the added filter neural network layers, to learn to recognize a harmful response, especially when harmful information might be generated part-way through, i.e. deeper within, a response. Further, without the added filter neural network layers, a process that involves fine-tuning a pre-trained neural network in this way can fail to generalize well from the distribution of the training examples. Adding filter neural network layers as described herein can address this and improve generalization based on the training examples, and can hence reduce the risk of harmful responses, and can also reduce the risk of jailbreaking.

One aspect of the described subject matter also provides a method of mitigating the risk of a harmful response in inference, in particular when harmful information might be generated part-way through the response.

The described techniques enable the pre-trained generative neural network and the filter layers to be implemented on different computing devices or systems (in general in this specification “computing device” and “computing system” are used synonymously). This can provide various advantages.

As one example, during or after training multiple different instances of the filter layers can be maintained in parallel, e.g. on multiple different computing devices, to provide multiple different alignments for the pre-trained generative neural network.

As another example, implementing the filter layers on a different computing device or system to the computing device or system that implements the pre-trained generative neural network can facilitate determining an alignment for an existing pre-trained generative neural network. This is because the adapted neural network can be obtained with little modification to the existing pre-trained generative neural network. This can also provide improved security by either protecting the pre-trained parameters, e.g. weights, of the generative neural network; or the (trained) trainable parameters of the one or more filter layers, which reflect a particular alignment of the adapted neural network; or both. In some implementations, the pre-trained parameters of the generative neural network and the trainable parameters of the one or more filter layers can be stored in different (separate) memories; and optionally access to one or the other or both can be restricted.

Some particular implementations of the filter layer neural network architecture are also adapted to parallel processing. Thus, as a further example (which may be implemented in conjunction with the foregoing examples), the filter layers can be implemented on a different computing device or system that has, e.g., less memory or computing capability than a device or system hosting the existing pre-trained generative neural network.

In general, implementations of the described techniques provide architectures with better inductive biases that can provide stronger and more robust alignment and, in implementations, better safety controls.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a pre-trained generative neural network.

FIG. 2 shows an example of an adapted neural network.

FIG. 3 shows a further example of a pre-trained generative neural network and an adapted neural network.

FIG. 4 shows an example of a filter layer for the adapted neural network of FIG. 2.

FIG. 5 shows an example of a filter layer for the adapted neural network of FIG. 3.

FIG. 6 is a flow diagram of an example process for aligning the output of a pre-trained generative neural network.

FIG. 7 shows an example of a generative neural network system.

FIG. 8 is a flow diagram of an example process for responding to a request.

Like reference numbers and designations in the various drawings indicate like elements.

### DETAILED DESCRIPTION

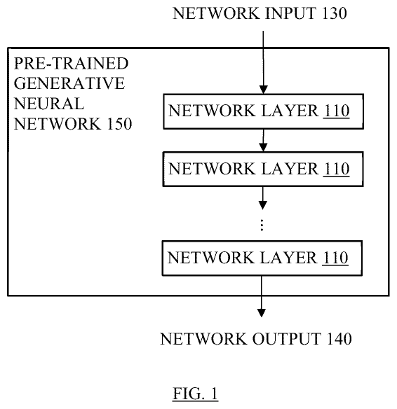

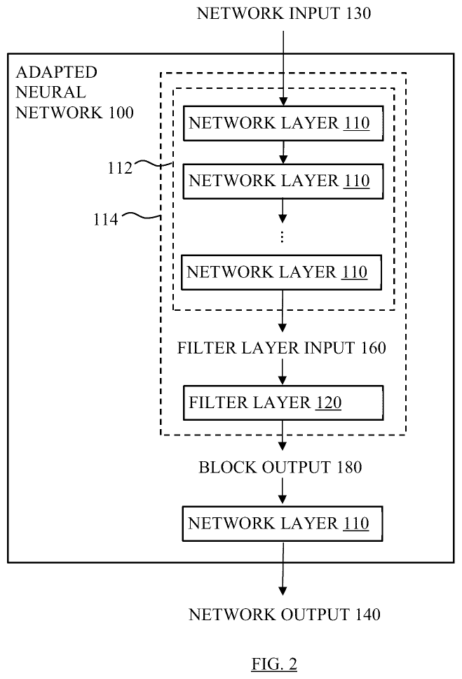

FIG. 1 shows an example pre-trained generative neural network 150, while FIG. 2 shows an example of an adapted neural network 100. The pre-trained generative neural network 150 and the adapted neural network 100 are examples of systems implemented as computer programs on one or more computers in one or more locations in which the systems, components, and techniques described below are implemented.

The pre-trained generative neural network 150 of FIG. 1 comprises a plurality of pre-trained neural network layers 110, each having a plurality of pre-trained trainable parameters (e.g., neural network weights and/or biases). The output of each of the pre-trained neural network layers 110 except the last is used as input to the next pre-trained neural network layers 110 in the neural network 150. The pre-trained generative neural network 150 is configured to process a network input 130 using the plurality of pre-trained neural network layers 110 to generate a network output 140, e.g., a response to a request provided in the network input 130. As described in detail below, the pre-trained generative neural network can be configured to perform one or more tasks on the network input 130 to generate the network output 140, such as an image, video, or audio processing task, generating control signals for a mechanical agent, and so on.

The adapted neural network 100 of FIG. 2 is obtained from a pre-trained generative neural network, such as the pre-trained generative neural network 150 of FIG. 1, by adding one or more filter layers 120 to the pre-trained generative neural network. This can be done, for one or more stacks of the pre-trained neural network layers in the pre-trained neural network, by inserting a filter layer after the stack of pre-trained neural network layers. For example, the adapted neural network 100 can be obtained by inserting the filter layer 120 after each stack of a plurality of stacks of the pre-trained neural network layers in the pre-trained neural network.

In the implementation shown in FIG. 2, the plurality of pre-trained neural network layers 110 are arranged in stacks 112, with each stack 112 comprising a respective sequence of the plurality of pre-trained neural network layers 110 of the pre-trained generative neural network. For example, a stack 112 of the pre-trained neural network layers 110 can comprise a sequence of the neural network layers between an input of the pre-trained generative neural network and an output of the pre-trained generative neural network, in which an output of one neural network layer 110 provides an input to a next neural network layer 110 in the sequence. As one example, the stack 112 of the pre-trained neural network layers 110 may comprise, e.g., a stack that includes one or more pre-trained attention neural network layers, e.g. self-attention neural network layers.

A respective filter layer 120 is added to each stack 112 to form a filtered block 114 comprising the stack 112 of pre-trained neural network layers 110 and the filter layer 120. The filter layer 120 is configured to process a filter layer input 160 comprising an output from the corresponding stack 112 of the pre-trained neural network layers 110, in accordance with trainable parameters of the filter layer 120 (“filter layer trainable parameters”), to generate a block output 180. A filter layer may be inserted, every n layers, e.g. every 10 layers, in some examples.

In general, inserting a filter layer 120 involves providing an output from the stack 112 of pre-trained neural network layers to an input of the filter layer 120, and providing an output from the filter layer to a next neural network layer 110 after the stack of pre-trained neural network layers 110 in the pre-trained neural network. The output from the filter layer can be combined with the output from the stack (the input to the filter layer), e.g. by summing. Thus, the next neural network layer 110 can process the output from the filter layer 120 together with the output from the stack 112 of pre-trained neural network layers.

For example, a next neural network layer 110 after the stack 112 of pre-trained neural network layers is configured to process at least the block output 180, e.g. it can process a combination of the block output 180 and the output from the stack 112 of pre-trained neural network layers 110. For example, for each filtered block 114 in the adapted neural network 100 except the last, the block output 180 can be provided as an input to a next filtered block 114. For the last filtered block 114, the block output 180 can be provided as an input to a final one or more of the neural network layers 110 of the pre-trained generative neural network.

In principle, the filter layer 120 may comprise any type of neural network layer 110 such as one or more linear neural network layers (neural network layers without a non-linearity), one or more feedforward neural network layers, one or more recurrent neural network layers, one or more convolutional neural network layers, one or more attention neural network layers, or one or more normalization layers, and so on. Some particularly useful examples are given later. The filter layer 120 has a plurality of filter layer trainable parameters, e.g. weights.

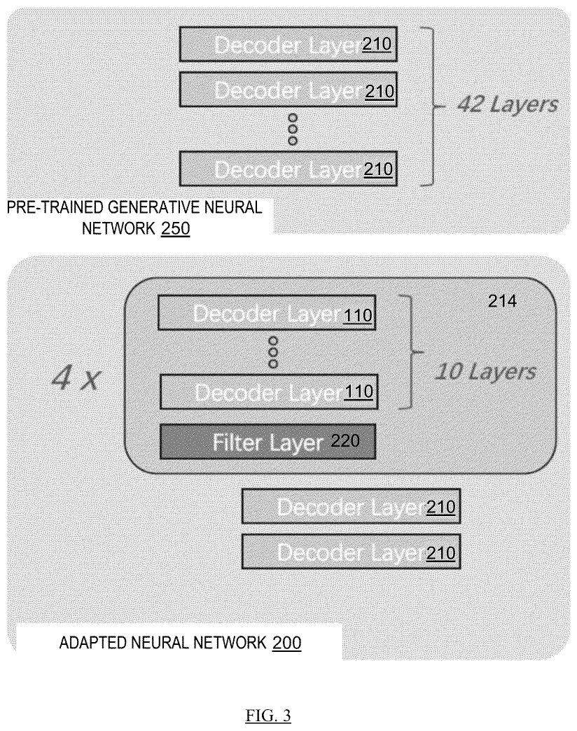

FIG. 3 shows a specific example of a pre-trained generative neural network 250 that comprises 42 pre-trained neural network layers, referred here as “decoder” layers 210. FIG. 3 also shows an adapted neural network 200 obtained by inserting a filter layer 220 after every ten decoder layers 110 of the pre-trained generative neural network 250, such that there are four filtered blocks 214 that each comprise a respective stack of ten decoder layers 110. A stack of the remaining two decoder layers 210, which are not part of any of the four filtered blocks 214 process the output of the final filtered block 214 to generate a network output for the adapted neural network 200.

An example computer-implemented method of alignment of the output of a pre-trained generative neural network, such the pre-trained generative neural network 150, 250 of FIGS. 1 and 3, uses a dataset of training examples.

The method involves obtaining an adapted neural network. In the adapted neural network each filter layer is configured to process a filter layer input comprising an output from a stack of the pre-trained neural network layers, in accordance with trainable parameters of the filter layer (“filter layer trainable parameters”), to generate a block output. A next neural layer after the stack of pre-trained neural network layers is configured to process at least the block output, e.g. it can process a combination of the filter layer output and the output from the stack of pre-trained neural network layers.

In some implementations the method includes obtaining the pre-trained neural network, and adapting the neural network to obtain the adapted neural network by inserting the filter layer after the or each stack of pre-trained neural network layers.

In some implementations the method includes obtaining the pre-trained neural network, and adapting the neural network to obtain the adapted neural network by inserting the filter layer after the or each stack of pre-trained neural network layers.

As one example the dataset of training examples can be collected by asking humans to provide suitable examples. As another example the dataset of training examples can be compiled automatically, e.g. by generating many potential training examples and then categorizing each using, e.g. a trained LLM or VLM, and selecting as training examples those examples that fit the desired alignment category.

Generally, each training, e.g. harmful, example comprises a training (harmful) request, e.g. in the form of a query. Each training request has a predetermined (safe) response, e.g. that indicates refusal of the request. The same predetermined (safe) response can be used for each of the (harmful) training examples, i.e. it may not be provided separately for each training example. That is, the training requests in the training dataset are examples of requests for which the predetermined response is desired.

As an example, in the case of an LLM or VLM, the predetermined response can be a special token and/or one or more tokens representing a predetermined text sequence such as “Sorry”, or “I am unable to . . . ”, or “I am unable to fulfil your request”. As described later, in the training dataset optionally each training, e.g. harmful, example can be paired with a corresponding undesired, e.g. harmful, response.

Optionally a training example, e.g. harmful, example can include a prefix, e.g. a prompt intended for jailbreaking the pre-trained neural network. A harmful request can be, e.g. a request to provide harmful output such as offensive or potentially dangerous output (e.g. by answering a question about how to do something harmful).

The adapted neural network 100 can be trained using the training examples. In particular, for each of a plurality of the training examples the adapted neural network 100 can process the training request in the training example (e.g., by providing the request in the network input 130), to obtain a neural network output 140 from the adapted neural network 100.

The adapted neural network 100 is trained using a training objective, based on the neural network output 140 and the predetermined response, to increase a likelihood of the predetermined response. Any conventional training objective can be used, e.g. a cross-entropy loss (or per-token cross-entropy loss) or a negative log likelihood objective that is to decrease, e.g. minimize, a negative log likelihood of the predetermined response. In implementations, the training objective can be dependent on a difference between the neural network output 140 and the predetermined response.

In implementations, training the adapted neural network involves adjusting the trainable parameters of the one or more filter layers 120 whilst keeping the pre-trained trainable parameters of the plurality of pre-trained neural network layers 110 fixed. This can be done by backpropagating gradients of the training objective and updating the trainable parameters, e.g. weights, of the filter layer(s), e.g. using any appropriate gradient descent optimization algorithm such as Adam or another optimization algorithm (see e.g., Kingma et al. arXiv:1412.6980). In implementations, the backpropagating is performed through both sets of parameters, i.e. the pre-trained trainable parameters and the trainable parameters of the filter layer(s), but only the trainable parameters of the filter layer(s) are updated.

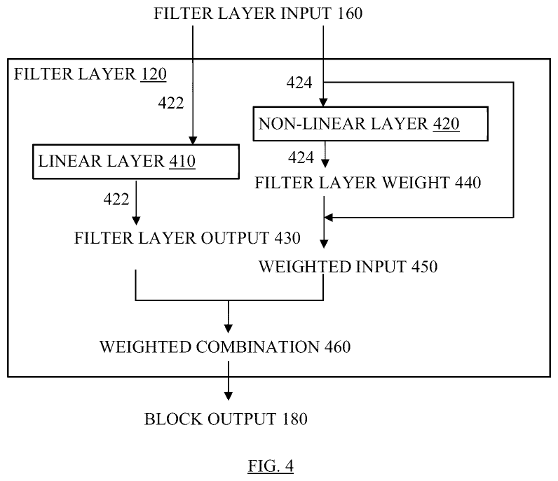

FIG. 4 shows an example of a filter layer 120 for the adapted neural network 100, 200 of FIG. 2 and/or FIG. 3. The filter layer 120 comprises a first, linear processing path 422, to provide a filter layer output 430, and a second, non-linear processing path 424, in parallel with the first path, to provide a filter layer weight 440. In this example, the first processing path 422 comprises a linear layer 410 configured to process the filter layer input 160 to generate the filter layer output 430. In this example, the second processing path 424 comprises one or more non-linear layers 420 configured to process the filter layer input 160 to generate the filter layer weight 440. The filter layer 120 is further configured to scale the filter layer input 160 with the filter layer weight 440 to determine a weighted input 450 which is then combined with the filter layer output 430 to obtain a weighted combination 460. The block output 180 then comprises the weighted combination 460.

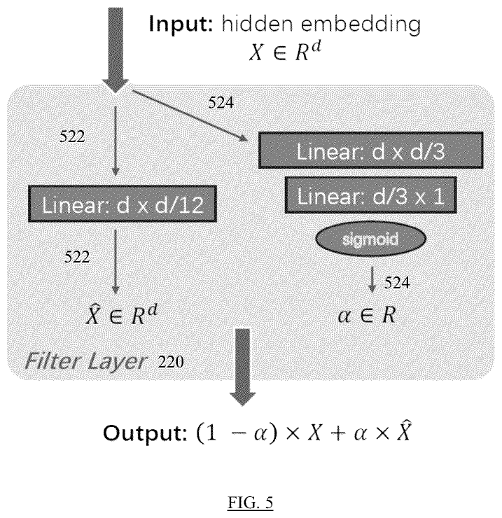

FIG. 5 is an example of a filter layer 220 for the adapted neural network 100, 200 of FIG. 2 and/or FIG. 3. The example filter layer 220 receives the filter layer input, which in this example comprises an embedding (X) output by the preceding neural network layer 110, 210. The filter layer 220 has a first, linear processing path 522, to provide a transformed input (\hat{X}), and a second, non-linear processing path 524, in parallel with the first path, to provide a filter layer weight (α). The filter layer output 180 in this example comprises the weighted combination

$$( 1 - α ) X + α \hat{X} .$$

As previously described, in some implementations the next neural layer after the stack of pre-trained neural network layers can be configured to process a combination of the layer output (\hat{X}) and the output from the stack of pre-trained neural network layers (X). Processing the training request in the training example using the adapted neural network 100, 200 can involve processing the filter layer input (X) using the filter layer (and in accordance with the trainable parameters of the filter layer) to generate a filter layer weight, a. A weighted combination of the filter layer output and the output from the (respective) stack of pre-trained neural network layers can then be determined in accordance with the filter layer weight, e.g. weighting the filter output by the filter layer weight. The weighted combination can then be processed using the next neural layer after the stack of pre-trained neural network layers.

The filter layer input can be processed using one or more non-linear neural network layers of the filter layer, to generate the filter layer weight. The filter layer weight can define a weight of the of the filter layer output in the weighted combination.

Processing the training request in the training example, using the adapted neural network 100, 200, can involve processing the filter layer input using one or more linear neural network layers of the filter layer, to generate the filter layer output. That is, in implementations the filter layer output is a linear function of the filter layer input.

In some implementations the filter layer is configured for parallel processing of (i) the filter layer input, using one or more linear neural network layers, to generate the filter layer output; and (ii) the filter layer input using the filter layer to generate the filter layer weight. For example, the filter layer can comprise a first, linear processing path 422, 522 to provide the filter layer output (\hat{X}), and a second, non-linear processing path 424, 524, in parallel with the first path, to provide the filter layer weight (α). Each path is coupled to the filter layer input (X). The second, non-linear processing path may comprise one or more linear layers followed by a non-linear layer.

As an example, the weighted combination processed using the next neural layer after the stack of pre-trained neural network layers can be given by (1−α)X+α\hat{X}.

Training the adapted neural network can involve initializing (e.g. randomly) the trainable parameters of the filter layer, initializing the filter layer weight to zero, and then adjusting the trainable parameters of the filter layer and the filter layer weight during the training. In this way, the one or more filter layers initially have no effect and the adapted neural network is fine-tuned during alignment to move the filter layer weight away from zero.

The pre-trained generative neural network 150, 250 can be implemented on a first computing device and the plurality of pre-trained trainable parameters can be maintained in a memory of the first computing device. Each of the one or more filter layers 120, 220 can be implemented on one or more second, different computing devices, e.g. with less memory. Training the system can then involve maintaining and adjusting the trainable parameters of the one or more filter layers in the memory of the second, different computing device, leaving the parameters of pre-trained model alone (albeit backpropagating through both sets of parameters).

In some implementations, the pre-trained generative neural network 150, 250 and the adapted neural network 100, 200 are each configured to process an input sequence of tokens to generate an output token to extend the input sequence.

As one example the adapted neural network (and the pre-trained neural network) can generate an output comprising scores (logits) defining a probability distribution over a token vocabulary that can be sampled to obtain the output token. This can be used, e.g., for generating a text token or for generating an image token where, say, the vocabulary defines a codebook for image generation (e.g. using a VQ-VAE). As another example, the adapted neural network (and the pre-trained neural network) can generate an output that defines a value for a soft token, i.e. a token with continuous scalar or vector value. This can be used, e.g. for defining values of pixels or groups of pixels of an image, or audio signal values of an audio signal, or for conditioning another model such as a diffusion model, in general to generate and desired type of output.

Processing the training request in the data item using the adapted neural network can involve tokenizing the training request to generate a request (query) token sequence that represents the training request as a sequence of tokens. The request token sequence can then be processed, e.g. autoregressively, using the adapted neural network obtain the neural network output comprising an output sequence of tokens. For example, the adapted neural network can process a current input sequence of tokens comprising the request token sequence, to generate an output token that can be appended to current input sequence of tokens to extend this, repeating e.g. until an end of sequence token or a predetermined number of tokens has been generated.

The training objective may then comprises a (per-token) cross-entropy loss between the output sequence of tokens and a predetermined response token sequence that represents the predetermined response as a sequence of tokens, e.g. an objective to maximize π_{θ}(r|x), where θ denotes the parameters of the adapted neural network (both the pre-trained parameters and the trainable parameters of the filter layer(s)), r denotes the predetermined, e.g. “safe”, response, and x denotes the e.g. “harmful” training request (or query).

In general, the pre-trained neural network 150, 250 and the adapted neural network 100, 200 can each comprise a stack of attention neural network layers. In some implementations, the pre-trained neural network and the adapted neural network each comprise a Transformer neural network, e.g. an encoder-decoder Transformer or a decoder-only Transformer. In some implementations, the pre-trained neural network and the adapted neural network may combine a recurrent neural network and attention, e.g. mixing gated recurrences with local attention as described in De et al., Griffin, arXiv:2402.19427, 2024, in which case the filter layer input may comprise a hidden state of the recurrent model.

In general, a Transformer-based architecture (neural network) can be one in which is characterized by having a succession of self-attention neural network layers. A self-attention neural network layer has an attention layer input for each element of the input and is configured to apply an attention mechanism over the attention layer input to generate an attention layer output for each element of the input. There are many different attention mechanisms that may be used.

An attention neural network layer has an attention layer input for each element of the input sequence and is configured to apply an attention mechanism over the attention layer input to generate an attention layer output for each element of the input sequence. The attention layer input and the attention layer output comprise vectors of the same dimension, and the attention neural network layers may have residual connections. An example self-attention layer can be one that maps a query and a set of key-value pairs, each derived from an input to the self-attention layer (e.g. all vectors), to an output from which an output of the self-attention layer is derived. The output can be computed as a weighted sum of the values, weighted by a similarity function of the query to each respective key.

Training based on a predetermined, safe response can be relatively shallow because once the safe response, e.g. “Sorry”, has been generated the remainder of the response will generally be harmless. Thus, the training can focus on predicting the first token or few tokens of the safe response. The training can be deepened by including some harmful tokens in the prompt, which can be intuitively understood as teaching the model to check that the output is safe every time a new token is generated. Put differently, given a tricky prompt, x, appending some harmful tokens can more readily expose a harmful intention, and during training this additional information can be useful to help train the model to rectify an earlier error.

Thus, in some implementations each training example, e.g. harmful example, comprises the training request and a corresponding undesired, e.g. harmful, response. The method can then involve tokenizing the undesired (harmful) response to generate an undesired (harmful) response token sequence, h, that represents the undesired (harmful) response as a sequence of tokens. The process can select the first k tokens of the undesired (harmful) response token sequence, hₛₖ (where k≥1) to obtain the input sequence of tokens for the adapted neural network. The training request in the data item can be processed using the adapted neural network 100, 200 by processing this input sequence of tokens using the adapted neural network, to obtain the output sequence of tokens. The adapted neural network 100, 200 can be trained using the training objective to increase a likelihood of obtain the output sequence of tokens including the predetermined response token sequence, e.g. backpropagating gradients of the training objective as previously described. In this case, the model (adapted neural network) can be trained to generate a text output that need not be a meaningful sentence, e.g. it might start with a question, continue with part of a harmful response, and then break into the response to continue with, e.g. “Sorry” or a similar safe response.

The training objective can be dependent on a difference between the output sequence of tokens and a predetermined response token sequence that represents the predetermined response as a sequence of tokens, e.g. dependent on a per-token cross-entropy loss determined between these sequences.

In implementations, the value of k can be selected randomly, e.g. from a range between 1 and a maximum k-value, where the maximum k-value can be, e.g. the length of the particular undesired (harmful) response.

As one particular example, the training objective can be to minimize a negative log likelihood −log π(r|x, h_{≤k}) where π(⋅|x) denotes the output of the adapted neural network, e.g. a score or probability distribution defined from which a next token can be sampled. A value of this negative log likelihood can be averaged over the training examples, e.g. a dataset of triplets (x, h, r) comprising a training request such as a harmful query, an undesired, e.g. harmful response, and a predetermined, e.g. safe response such as refusal to answer.

As another example, the training objective can be to minimize

$$\{ - log π ( r \vert x , {h}_{\leq k} ) - {{\sum }_{i = 0}^{\vert h \vert}}_{} log π ( {r}^{′} \vert x , {h}_{\leq i} ) \}$$

where r′ can be r or the first token of r, and |h| is the length of the undesired response token sequence.

In some implementations, and as previously described, the output of the pre-trained generative neural network is aligned to mitigate a risk of harmful output, the training examples comprise training requests, e.g. queries, likely to elicit an undesirable, harmful response, and the predetermined response is a safe response (answer).

The pre-trained generative neural network can comprise a language model (e.g. LLM) or vision language model (VLM) neural network.

A request (or network input), such as a training request, as described herein, may comprise (but is not limited to) one or more of text, an image, and audio. Similarly, a response (or network output) to the request may also comprise (but is not limited to) one or more of text, an image, and audio. Here text can be in a natural or computer language, i.e. text that includes computer code.

As another example, the request may comprise a request, e.g. a text request, to generate text e.g. computer code, an image, or audio, or an action of an agent such as a mechanical agent, e.g. a robot, and the predetermined response can indicate a refusal to generate the text, e.g. code identified as unsafe, image, audio or action. Some further examples are described later.

In another aspect there is described, a computer-implemented of responding to a request. This can involve receiving a request, tokenizing the request to obtain a sequence of tokens representing the request, and processing the sequence of tokens representing the request, using a generative neural network that has been aligned as described above, to generate an output sequence of tokens representing a response to the request. In response to the generative neural network identifying that the request should not be responded to the output sequence of tokens can indicate refusal of the request.

This can involve implementing the pre-trained generative neural network on a first computing device and maintaining the plurality of pre-trained trainable parameters of the plurality of pre-trained neural network layers in a memory of the first computing device. Each of the one or more filter layers can be implemented on a second different computing device, and the trained trainable parameters of the one or more filter layers can be maintained in a memory of the second, different computing device.

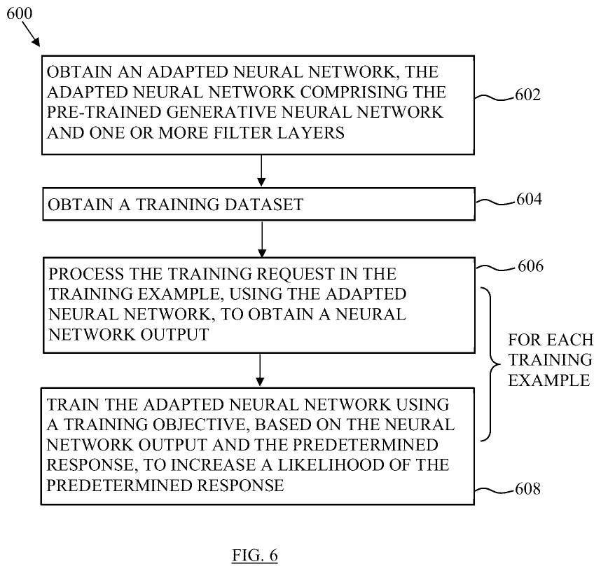

FIG. 6 is a flow diagram of an example process 600 for aligning the output of a pre-trained generative neural network. The pre-trained generative neural network comprising a plurality of pre-trained neural network layers each having a plurality of pre-trained trainable parameters. For convenience, the process 600 will be described as being performed by a system of one or more computers located in one or more locations. For example, a system comprising the pre-trained generative neural network 150 of FIG. 1 or the pre-trained generative neural network of FIG. 2, appropriately programmed in accordance with this specification, can perform the process 600.

The system obtains (step 602) an adapted neural network, the adapted neural network comprising the pre-trained generative neural network and one or more filter layers. Each filter layer is configured to process a filter layer input comprising an output from a stack of the pre-trained neural network layers, in accordance with trainable parameters of the filter layer, to generate a filter layer output. A next neural network layer after the stack of pre-trained neural network layers is configured to process at least the filter layer output.

The system then obtains (step 604) a training dataset comprising training examples. Each training example comprises a training request, each training request having a predetermined response that indicates refusal of the request.

For a plurality of the training examples, the system processes (606) the training request in the training example, using the adapted neural network, to obtain a neural network output, and trains the adapted neural network using a training objective, based on the neural network output and the predetermined response, to increase a likelihood of the predetermined response. Training the adapted neural network can, for example, comprise adjusting the trainable parameters of the one or more filter layers whilst keeping the pre-trained trainable parameters of the pre-trained neural network layers fixed.

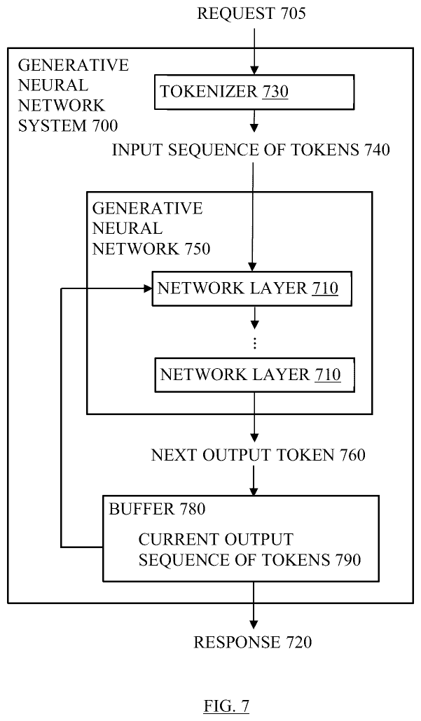

FIG. 7 shows a generative neural network system 700 that is configured to receive a request 705 and generate a response 720 comprising an output sequence of tokens. The generative neural network system 700 is an example of a system implemented as computer programs on one or more computers in one or more locations in which the systems, components, and techniques described below are implemented.

The generative neural network system 700 comprises a tokenizer 730 configured to tokenize the request to obtain an input sequence of tokens 740 representing the request 705 and a trained generative neural network 750 that comprises a plurality of neural network layers 710. The generative neural network 750 is configured to generate an output sequence of tokens by, for each successive token of the output sequence of tokens, processing the input sequence of tokens 740 and a current output sequence of tokens 790 (initially a null sequence) stored in a buffer 780, to generate a next output token 760 for the output sequence of tokens. Any suitable generative neural network 750 can be used. In some implementations, the generative neural network can have been aligned as described above. For example, the generative neural network 750 can comprise a pre-trained generative neural network 150 250 as described above in connection with FIGS. 1 and 3, or an adapted neural network 100, 200 as described above in connection with FIGS. 2 and 3.

The generative neural network system 700 is configured to determine, for each successive next output token 760 generated by the generative neural network 750, whether the next output token 760 is a traceback token. In response to determining that the next output token 760 is a traceback token, the generative neural network system 700 flushes the buffer 780 and generates the response 720 (i.e., an output) indicating refusal of the request 705. Otherwise, the generative neural network system 700 updates the buffer 780 to append the next output token 760 to the current output sequence of tokens 790. In that case, when the current output sequence of tokens 790 is complete, e.g., the next output token 760 is an End of Sequence toke (i.e., terminating) token. the current output sequence of tokens 790 is provided in the response 790. In some implementations, the generative neural network system 700 is configured to, in response to determining that a length of the current output sequence of tokens 790 in the buffer 780 exceeds a threshold (i.e., a threshold number of tokens) release the current output sequence of tokens 790 for responding to the request. The released tokens 790 can, for example, then be included in the response 720, or undergo further processing to generate the response 720.

Where a model (i.e., generative neural network) has already generated some harmful content but later realizes this is wrong and issues a refusal there is a risk that the earlier generated harmful content has already caused damage. However, a model typically recognizes its errors swiftly, e.g. within the first 50 tokens. Thus, for online streaming, the server can withhold the initial few tokens generated. If the model does not express any regret during this phase, these tokens can be released to users; otherwise, only the subsequent refusal tokens are released. Implementing this mechanism can involve generating a special “traceback” token (that indicates regret). When the model regrets generating an output, it can first output this token to signal a corrective action. The model can be trained to generate the traceback token after some harmful tokens have been generated (e.g. by appending these as described above), and before a predetermined, e.g. safe response has been generated. Thus, in some implementations, the vocabulary of the generative neural network 750 can be extended to include the traceback token.

Thus, there is also described a computer-implemented method of responding to a request. The method can involve maintaining buffer storing a current output sequence of tokens. A request can be received and can be tokenized to obtain an input sequence of tokens representing the request.

An output sequence of tokens can be generated, e.g. autoregressively, by, for each successive token of the output sequence of tokens, processing the input sequence of tokens and the current output sequence of tokens (initially a null sequence), using a trained generative neural network to generate a next output token for the output sequence of tokens. The generative neural network can have been aligned as described above.

In response to determining that the next output token is a traceback token the process can flush the buffer and generate an output indicating refusal of the request, e.g. the traceback token. Otherwise, the buffer can be updated to append the next output token to the current output sequence of tokens.

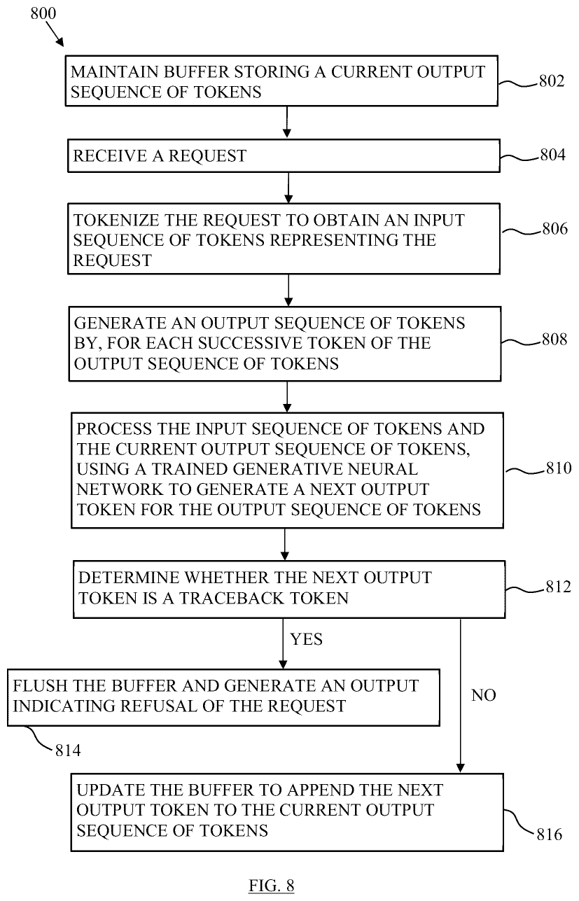

In response to determining that a length of the current output sequence of tokens in the buffer exceeds a threshold the current output sequence of tokens can be released for responding to the request. This aspect is further described with respect to FIG. 8.

FIG. 8 is a flow diagram of an example computer-implemented process 800 for responding to a request. For convenience, the process 800 will be described as being performed by a system of one or more computers located in one or more locations. For example, the generative neural network system 700 of FIG. 7, appropriately programmed in accordance with this specification, can perform the process 600.

The system maintains (step 802) a buffer storing a current output sequence of tokens.

The system receives (step 804) a request and tokenizes (step 806) the request to obtain an input sequence of tokens representing the request. The system then (step 808) generates an output sequence of tokens by, for each successive token of the output sequence of tokens, processing the input sequence of tokens and the current output sequence of tokens, using a trained generative neural network to generate a next output token for the output sequence of tokens.

The system then (step 812) determines whether the next output token is a traceback token. If the next output token is a traceback token, the system flushes the buffer and generates an output indicating refusal of the request (step 814). Otherwise, the system updates (step 816) the buffer to append the next output token to the current output sequence of tokens.

In some implementations of the above-described processes 600, 800, the tokens can represent text, e.g., words, wordpieces or characters, in a natural or computer language. For example, text may be received, e.g., as a series of encoded characters, e.g. UTF-8 encoded characters; such “characters” can include Chinese and other similar characters, as well as logograms, syllabograms and the like. A text encoder, i.e. a tokenizer, can process a sequence of text to represent the text as a series of text tokens from a vocabulary of text tokens, e.g. that each represent words, wordpieces or characters in a natural or computer language. The computer language may be any formal language used to communicate with a computer, e.g. a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens may be converted into audio data that represent speech corresponding to the text.

Also or instead, the tokens may represent an image. For example, a set (sequence) of input or output tokens can represent an image. Each image token may comprise a block encoding of values of the pixels in a different region of an image that maps a set of values of the pixels to a respective image token. The block encoder may comprise a neural network, e.g. having one or more (self-) attention layers, such as a Transformer neural network.

Also or instead, the tokens may represent an audio waveform. For example, a set (sequence) of input or output tokens can represent audio data representing an waveform e.g. instantaneous audio amplitude values or time-frequency audio data. Each image token may comprise a block encoding of the audio waveform in a different time segment of the audio that maps a set of values representing the audio waveform to a respective image token. The block encoder may comprise a neural network, e.g. having one or more (self-) attention layers, such as a Transformer neural network.

In a multimodal system, audio data or an image may be flagged by a start-of-audio token or start-of-image token.

In some applications. the neural network output comprises a policy output that defines an action or sequence of actions for an agent, e.g. an autonomous or semi-autonomous mechanical agent such as a robot or vehicle, acting in a real-world environment to perform a requested task or action. Then the alignment may be to reduce the likelihood of certain types of behaviour, e.g. undesirable behaviour, as represented by the training examples, e.g. to ensure that actions are safe. The training may be performed using a simulation of the agent acting in a simulation of the real-world environment before the agent is used in the real world environment. Here safe behaviour may be defined with reference to a set of parameters that define a region of safe operation of the mechanical agent, such as moving of a part of the agent e.g. robot to outside a defined (safe) region, or the agent e.g. robot applying greater than a defined (safe) force to an object, or the agent e.g. robot, or part thereof, moving greater than a defined (safe) speed.

As another example, in some applications the neural network output can define the result of determining the structure of a chemical or biological entity defined by the (training) request, e.g. having a particular property or function specified by the request, e.g. that could then be synthesised. The alignment can then be to refuse certain requests.

The generative neural network, and after training the adapted neural network, may be part of a generative neural network system.

In some implementations the generative neural network system is a multimodal system that is configured to process a request comprising one or more of text data, audio data defining an audio signal (e.g. as amplitude values of the audio signal or as a time-frequency representation of the audio signal), or a still or moving image (e.g. as image pixel values), to generate a data item that can similarly comprise text data, audio data, or a still or moving image.

For example, the request may comprise text and the data item may comprise an image or an audio signal that represents speech or an image generated in response to the text, e.g. described by the text. Also or instead, the request may comprise an audio signal that represents speech, or an image, and the data item may comprise text, e.g. that describes the request. For example, the generative neural network can be configured to perform a speech-to-text, e.g., transcription, task, or a scene description task, e.g., of a real-world scene.

As another, example the request may comprise an observation, e.g. of a real-world environment, e.g. from sensor such as a camera or other image sensor; and optionally additional information such as information defining a particular task to be deformed. The output data item may comprise agent control data that defines one or more actions to be performed by an agent, e.g. by a mechanical agent such as a robot or autonomous vehicle, to perform a task. The reward model(s) may, e.g., define a preferred trajectory of motion of the mechanical agent in the (real-world) environment.

In some implementations, the generative neural network system may comprise a language and/or image generation neural network system, that may have been trained before being fine-tuned by the above described method. The request may comprise a prompt, e.g. a natural or computer language prompt for the generative neural network system. The response may comprise a natural or computer language and/or image response to the prompt.

In general, and as previously described, the generative neural network system can have any appropriate architecture for processing the request to generate the data item.

As used herein an image may be any still or moving image, i.e. the image may be part of a video, in 2D or 3D, and may be a monochrome, color or hyperspectral image, i.e. comprising monochrome or color pixels. As defined herein an “image” includes a point cloud e.g. from a LIDAR system, and a “pixel” includes a point of the point cloud. An image may have been captured by a camera or other image sensor from the real world; and objects in the image may comprise physical objects, represented by the image.

### Example Hardware Implementations

In some implementations, the adapted neural network 100, 200, or the filter layer(s) 120, 220, can be stored on a user computing device, i.e. a device local to the user, such as a mobile device e.g. a mobile phone, or a smart speaker.

In some implementations, the adapted neural network can be implemented on a remote server in communication with a user computing device over a wired or wireless network communications link between the user computing device and the server.

The user computing device may be provided with an input mechanism, such as a text or voice interface, that enables user input from the user in a natural language. The user computing device may be provided with an output mechanism that provides a system output for the user in the or another natural language e.g. as speech or text; or in some other way, e.g. by displaying an image. The input and output mechanism may comprise, e.g., a keyboard, microphone, speaker, display, and/or camera.

As an example, the input mechanism may comprise a system configured to input audio data characterizing a speech waveform of speech representing the input from the user in a natural language, and configured to convert the audio data into tokens representing the speech in the natural language, e.g. representing a transcription of the spoken input. The output mechanism may comprise a system configured to receive tokens representing the output for the user in the or another natural language and a system configured to convert the received tokens into audio data representing a waveform of speech representing the output to the user in the natural language, i.e. representing spoken words.

As a further example, the adapted neural network can be deployed in an environment that enables a user to provide a request for the system, e.g. to process a multimodal request to generate a corresponding data item output. A users can provide the request, e.g., by way of a user interface or through an application programming interface (API). The request can be transmitted from a user device, e.g., over a data communications network such as the internet, to one or more computers implementing the system, e.g., in a data center. The system can generate a data item and then transmit the data item to a user device over a data communications network.

### Further Example Multimodal Applications

The generative neural network system may comprise a multimodal machine learning system such as a visual language model (VLM). That is, implementations of the generative neural network system can perform a multimodal task in which the request and data item, collectively, comprise data of multiple different types. As used herein text can include numbers, punctuation, special symbols, and so forth.

In some implementations, after training, a particular task that is to be performed by the adapted neural network can be described by part or all of a sequence of text in the request to the system. For example, in a request that includes an image such a prompt might specify “Generate a caption”, “Generate a description”, “Answer the following question: [about the image or video]”, or “Detect a person”. Where the system is used for an agent control task a prompt may define “Take the knife out of the drawer”, or “Q: What action should the robot take to take the knife out of the drawer?”. Also or instead, such a prompt may give one or more examples of a task to be performed. The adapted neural network can be trained on multiple natural and/or computer languages and the prompt may then specify a language to use.

A request as described above may specify a task to be performed. A few further examples of some machine learning tasks that can be performed by a system trained as described herein follow. The tasks described below may be tasks that require spatial awareness or other context from the image or video. For example, a prompt may ask “What is the object in the top left corner?”.

In general, for the tasks below the system can have been trained or fine-tuned on examples of the input and output for the task. For example, the system can have been trained using still or moving images containing one or more objects or actions, and corresponding sequences of text or other data e.g. describing or classifying the images. However large, “foundation” models can, in general, perform some tasks zero-shot, i.e. without having been specifically trained on those tasks.

As one example, the task may comprise an object or action detection task. For example, the response may comprise or represent text that describes or otherwise labels detected object(s) or action(s) in a request comprising an image or audio, and may include coordinates such as bounding-box coordinates for the detected object(s) or action(s), e.g. “10 20 90 100 cat 20 30 100 100 dog”

As another example, the task may comprise a classification task, e.g. an object or action classification task. The response may comprise data, e.g. text, that classifies the object(s) or action(s) in represented in the conditioning data, e.g. in an image or audio, into one of a plurality of classes, or that otherwise classify object(s) or action(s) represented in the conditioning data.

As another example, the task may comprise a still or moving image describing task, e.g. a captioning task (which, as used here, includes an audio description task to explain what is happening in an image). The response may comprise data, e.g. text, describing an image or video in the conditioning data. For example, the response may provide a caption or description, or it may count objects in the image or video, or it may provide some other form of description.

As another example the task may comprise a still or moving image question-answering task. The response may comprise data, e.g. text, that answers a question about the request, e.g. image or audio, where the question is also specified in the request, e.g. as sequence of text. This may be used, e.g., to answer questions about visual plots and charts or about sounds.

As another example, the task may comprise a character or word recognition task, e.g. an OCR (optical character recognition) task. The request may comprise a still or moving image and the response may comprise text that represents characters or words in the request, e.g. in a natural language.

As another example, the task may comprise a still or moving image generation task. The response may comprise image data defining values for pixels of a still or moving image, and the request, e.g. a sequence of text, may describe or characterize the image to be generated. Merely as an example, an image of a plot or chart may be generated to represent the request, e.g. comprising text.

As another example, the task may comprise a computer language text generation task. The conditioning data may comprise a natural language description of a task to be performed, and optionally an image (if the task is to be performed on or in relation to an image), and the response may comprise text in a computer language to perform the task, e.g. a task of analyzing the content of the image to provide a result of the analysis or to search for information relating to the content of the image.

As a particular example, the computer language in the response may comprise computer language for invoking a function or calling one or more external APIs. Merely as one example, such a data item may comprise data formatted as a JSON object. As previously, the request may define the task to be performed and may also include an image in relation to which the task is to be performed. In general, the task can involves manipulation of particular types of data that may benefit from access to an API such as mathematical data, date/time related data, scientific data, recent data that may post-date training of the system (that may be accessed by a search function or API), and so forth; and the response may comprise text in a computer language for performing the task. The method may then include using the text in the computer language to perform the task.

In general, where the response comprises text this may be converted to speech representing the text, and an audio (speech) output provided.

In some implementations, the task comprises an agent control task in which the agent interacts with an environment to perform the agent control task. In these implementations the request can include an observation characterizing the environment. For example, the request can include a sequence of text that defines the task to be performed by the agent and the image can represent an observation of the environment, e.g. captured by a camera or other imaging device from a real-world environment. The response can comprise an action selection output, e.g. including text, that is used to select one or more actions to be performed by the agent in the environment in response to the observation. As an illustration the response may define an action as text such as “A: 132 114 128 5 25 156”, that can be converted into a control signal for a mechanical agent, such as a robot, e.g. “ΔT=[0.1,−0.2,0] ΔR=[10°,25°,−7°]”. The action selection output may also or instead define one or more low-level skills, e.g. from a vocabulary of previously learnt skills. As before, the sequence of text in the request to the system may describe the task to be performed, e.g. “What action should the robot take to [perform task]”. Examples of systems for controlling an agent that may be fine tuned as described herein can include PaLM-E (Driess et al. arXiv:2303.03378), RT-1 (Brohan et al. arXiv:2212.06817), and RT-2 (Brohan et al. arXiv:2307.15818).

In some agent control implementations, the environment is a real-world environment and the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot or other mechanical agent interacting with the environment to accomplish a specific task, e.g., to locate or manipulate an object of interest in the environment or to move an object of interest to a specified location in the environment or to navigate to a specified destination in the environment. In these implementations, the observations may include, e.g., one or more of: images, object position data, and sensor data to capture observations as the agent interacts with the environment. The actions may define control signals to control the robot or other mechanical agent, e.g., positions, torques, or other control signals for the parts of the mechanical agent, or higher-level control commands.

In some agent control implementations, the agent may be a human agent and the environment may be a real-world environment. For example, the agent can be a human user of a digital assistant such as a smart speaker, smart display, or some other device that is used to instruct the user to perform actions. The task may be any real-world task that the user wishes to perform. The observations may be obtained from an observation capture subsystem, e.g. a monitoring system such as a video camera or sound capture system, to capture visual observations of the user performing the task. The actions may comprise instructions in the form of, e.g., text, image, video, or audio data such as speech, that guide the user in performing the task.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Aspects of the present disclosure are also set out in the following numbered clauses:

Clause 1. A computer-implemented method of alignment of the output of a pre-trained generative neural network based on a dataset of training examples, the pre-trained generative neural network comprising a plurality of pre-trained neural network layers each having a plurality of pre-trained trainable parameters, the method comprising:
obtaining an adapted neural network, the adapted neural network comprising the pre-trained generative neural network and one or more filter layers, wherein
each filter layer is configured to process a filter layer input comprising an output from a stack of the pre-trained neural network layers, in accordance with trainable parameters of the filter layer, to generate a filter layer output, and wherein a next neural network layer after the stack of pre-trained neural network layers is configured to process at least the filter layer output;
obtaining a training dataset comprising training examples, each training example comprising a training request, each training request having a predetermined response that indicates refusal of the request; and,
for a plurality of the training examples:
processing the training request in the training example, using the adapted neural network, to obtain a neural network output; and
training the adapted neural network using a training objective, based on the neural network output and the predetermined response, to increase a likelihood of the predetermined response; wherein
training the adapted neural network comprises adjusting the trainable parameters of the one or more filter layers whilst keeping the pre-trained trainable parameters of the pre-trained neural network layers fixed.

Clause 2. The method of clause 1, wherein the adapted neural network has been obtained from the pre-trained generative neural network by, for a plurality of stacks of the pre-trained neural network layers in a succession of stacks of the pre-trained neural network layers in the pre-trained generative neural network:
inserting a filter layer after each respective stack of pre-trained neural network layers, wherein:
each of the filter layers is configured to process the output from the respective stack of pre-trained neural network layers to generate the filter layer output, and
the next neural layer after the respective stack of pre-trained neural network layers is configured to process at least the filter layer output.

Clause 3. The method of clause 1 or 2, wherein the next neural layer after the stack of pre-trained neural network layers is configured to process a combination of the filter layer output and the output from the stack of pre-trained neural network layers; and
processing the training request in the training example, using the adapted neural network, to obtain the neural network output comprises:
processing the filter layer input using the filter layer to generate a filter layer weight; and
determining a weighted combination of the filter layer output and the output from the stack of pre-trained neural network layers in accordance with the filter layer weight; and
processing the weighted combination using the next neural layer after the stack of pre-trained neural network layers.

Clause 4. The method of clause 3, wherein processing the filter layer input using the filter layer to generate the filter layer weight comprises:
processing the filter layer input using one or more non-linear neural network layers of the filter layer, to generate the filter layer weight.

Clause 5. The method of any of clauses 3-4, wherein the filter layer weight defines a weight of the of the filter layer output in the weighted combination; and wherein training the adapted neural network comprises:
initializing the trainable parameters of the filter layer;
initializing the filter layer weight to zero; and
adjusting the trainable parameters of the filter layer and the filter layer weight during the training.

Clause 6. The method of any of clauses 1-5, wherein processing the training request in the training example, using the adapted neural network, to obtain the neural network output comprises:
processing the filter layer input using one or more linear neural network layers of the filter layer, to generate the filter layer output.

Clause 7. The method of clause 6 when dependent upon any of clauses 3-5, comprising processing in parallel i) the filter layer input, using one or more linear neural network layers, to generate the filter layer output; and ii) the filter layer input using the filter layer to generate the filter layer weight.

Clause 8. The method of any of clauses 1-7, comprising:
implementing the pre-trained generative neural network on a first computing device and maintaining the plurality of pre-trained trainable parameters in a memory of the first computing device; and
implementing each of the one or more filter layers on a second, different computing device.

Clause 9. The method of any of clauses 1-8, wherein the predetermined response is common to all the training examples.

Clause 10. The method of any of clauses 1-9, wherein training the adapted neural network using the training objective, based on the neural network output and the predetermined response, to increase the likelihood of the predetermined response comprises backpropagating gradients of the training objective, wherein training objective is dependent on a difference between the neural network output and the predetermined response.

Clause 11. The method of any of clauses 1-10, wherein
the pre-trained generative neural network and the adapted neural network are each configured to process an input sequence of tokens to generate an output token to extend the input sequence; wherein
processing the training request in the data item using the adapted neural network comprises:
tokenizing the training request to generate a request token sequence that represents the training request as a sequence of tokens, and
processing the request token sequence using the adapted neural network obtain the neural network output comprising an output sequence of tokens.

Clause 12. The method of clause 11, wherein the training objective comprises a cross-entropy loss between the output sequence of tokens and a predetermined response token sequence that represents the predetermined response as a sequence of tokens.

Clause 13. The method of clause 11 or 12, wherein
each training example comprises the training request and a corresponding undesired response; the method further comprising:
tokenizing the undesired response to generate an undesired response token sequence that represents the undesired response as a sequence of tokens;
selecting the first k tokens of the undesired response token sequence to obtain the input sequence of tokens for the adapted neural network; wherein
processing the training request in the data item using the adapted neural network comprises processing the input sequence of tokens using the adapted neural network, to obtain the output sequence of tokens; and further comprising
training the adapted neural network using the training objective to increase a likelihood of obtain the output sequence of tokens including the predetermined response token sequence.

Clause 14. The method of clause 13, wherein
training the adapted neural network using the training objective to increase the likelihood of obtain the output sequence of tokens including the predetermined response token sequence comprises backpropagating gradients of the training objective,
wherein the training objective is dependent on a difference between the output sequence of tokens and a predetermined response token sequence that represents the predetermined response as a sequence of tokens.

Clause 15. The method of clause 13 or 14, comprising selecting k randomly from a range between 1 and a maximum k-value.

Clause 16. The method of any of clauses 11-15, the pre-trained generative neural network and the adapted neural network are each autoregressive neural networks, and wherein the plurality of pre-trained neural network layers comprises one or more attention layers.

Clause 17. The method of any of clauses 1-16, wherein aligning the output of the pre-trained generative neural network using the dataset of training examples comprises adapting the pre-trained generative neural network to mitigate a risk of harmful output; wherein the training examples comprise harmful examples; and wherein the predetermined response comprises a safe response.

Clause 18. The method of any of clauses 1-17, comprising:
obtaining the pre-trained generative neural network;
adapting the pre-trained generative neural network to obtain the adapted neural network by, for one or more of the stacks of the pre-trained neural network layers in the pre-trained generative neural network, inserting the filter layer after the stack of pre-trained neural network layers by:
providing the output from the stack of pre-trained neural network layers to the filter layer input; and
providing the filter layer output to the next neural layer after the stack of pre-trained neural network layers in the pre-trained generative neural network, for the next neural layer to process together with the output from the stack of pre-trained neural network layers.

Clause 19. The method of any of clauses 1-18, wherein the pre-trained generative neural network comprises a language model or vision language model neural network.

Clause 20. The method of clause 19, wherein the training request comprises a request to generate an image, and wherein the predetermined response indicates a refusal to generate the image.

Clause 21. A computer-implemented method of responding to a request, the method comprising:
receiving a request;
tokenizing the request to obtain a sequence of tokens representing the request; and
processing the sequence of tokens representing the request, using a generative neural network that has been aligned by the method of any of clauses 1-20, to generate an output sequence of tokens representing a response to the request; wherein
in response to the generative neural network identifying that the request should not be responded to the output sequence of tokens indicates refusal of the request.

Clause 22. The method of clause 21, wherein the generative neural network comprises a pre-trained generative neural network comprising a plurality of pre-trained neural network layers each having a plurality of pre-trained trainable parameters, and one or more filter layers with trainable parameters that have been trained by the method of any of clauses 1-20; the method comprising:
implementing the pre-trained generative neural network on a first computing device and maintaining the plurality of pre-trained trainable parameters of the plurality of pre-trained neural network layers in a memory of the first computing device; and
implementing each of the one or more filter layers on a second different computing device and maintaining the trained trainable parameters of the one or more filter layers in a memory of the second, different computing device.

Clause 23. A computer-implemented method of responding to a request, the method comprising:
maintaining a buffer storing a current output sequence of tokens;
receiving a request;
tokenizing the request to obtain an input sequence of tokens representing the request;
generating an output sequence of tokens by, for each successive token of the output sequence of tokens,
processing the input sequence of tokens and the current output sequence of tokens, using a trained generative neural network to generate a next output token for the output sequence of tokens;
in response to determining that the next output token is a traceback token flushing the buffer and generating an output indicating refusal of the request, otherwise
updating the buffer to append the next output token to the current output sequence of tokens.

Clause 24. The method of clause 23, comprising:
in response to determining that a length of the current output sequence of tokens in the buffer exceeds a threshold releasing the current output sequence of tokens for responding to the request.

Clause 25. A system comprising:
one or more computers; and
one or more storage devices communicatively coupled to the one or more computers, wherein the one or more storage devices store instructions that, when executed by the one or more computers, cause the one or more computers to perform the operations of the respective method of any one of clauses 1-24.

Clause 26. One or more non-transitory computer storage media storing instructions that when executed by one or more computers cause the one or more computers to perform the operations of the respective method of any one of clauses 1-24.

What is claimed is:

1. A computer-implemented method of alignment of the output of a pre-trained generative neural network based on a dataset of training examples, the pre-trained generative neural network comprising a plurality of pre-trained neural network layers each having a plurality of pre-trained trainable parameters, the method comprising:
obtaining an adapted neural network, the adapted neural network comprising the pre-trained generative neural network and one or more filter layers, wherein
each filter layer is configured to process a filter layer input comprising an output from a stack of the pre-trained neural network layers, in accordance with trainable parameters of the filter layer, to generate a filter layer output, and wherein a next neural network layer after the stack of pre-trained neural network layers is configured to process at least the filter layer output;
obtaining a training dataset comprising training examples, each training example comprising a training request, each training request having a predetermined response that indicates refusal of the request; and,
for a plurality of the training examples:
processing the training request in the training example, using the adapted neural network, to obtain a neural network output; and
training the adapted neural network using a training objective, based on the neural network output and the predetermined response, to increase a likelihood of the predetermined response; wherein
training the adapted neural network comprises adjusting the trainable parameters of the one or more filter layers whilst keeping the pre-trained trainable parameters of the pre-trained neural network layers fixed.

2. The method of claim 1, wherein the adapted neural network has been obtained from the pre-trained generative neural network by, for a plurality of stacks of the pre-trained neural network layers in a succession of stacks of the pre-trained neural network layers in the pre-trained generative neural network:
inserting a filter layer after each respective stack of pre-trained neural network layers, wherein:
each of the filter layers is configured to process the output from the respective stack of pre-trained neural network layers to generate the filter layer output, and
the next neural layer after the respective stack of pre-trained neural network layers is configured to process at least the filter layer output.

3. The method of claim 1, wherein the next neural layer after the stack of pre-trained neural network layers is configured to process a combination of the filter layer output and the output from the stack of pre-trained neural network layers; and
processing the training request in the training example, using the adapted neural network, to obtain the neural network output comprises:
processing the filter layer input using the filter layer to generate a filter layer weight; and
determining a weighted combination of the filter layer output and the output from the stack of pre-trained neural network layers in accordance with the filter layer weight; and
processing the weighted combination using the next neural layer after the stack of pre-trained neural network layers.

4. The method of claim 3, wherein processing the filter layer input using the filter layer to generate the filter layer weight comprises:
processing the filter layer input using one or more non-linear neural network layers of the filter layer, to generate the filter layer weight.

5. The method of claim 3, wherein the filter layer weight defines a weight of the of the filter layer output in the weighted combination; and wherein training the adapted neural network comprises:
initializing the trainable parameters of the filter layer;
initializing the filter layer weight to zero; and
adjusting the trainable parameters of the filter layer and the filter layer weight during the training.

6. The method of claim 1, wherein processing the training request in the training example, using the adapted neural network, to obtain the neural network output comprises:
processing the filter layer input using one or more linear neural network layers of the filter layer, to generate the filter layer output.

7. The method of claim 3,
wherein processing the training request in the training example, using the adapted neural network, to obtain the neural network output comprises:
processing the filter layer input using one or more linear neural network layers of the filter layer, to generate the filter layer output; and
comprising processing in parallel i) the filter layer input, using one or more linear neural network layers, to generate the filter layer output; and ii) the filter layer input using the filter layer to generate the filter layer weight.

8. The method of claim 1, comprising:
implementing the pre-trained generative neural network on a first computing device and maintaining the plurality of pre-trained trainable parameters in a memory of the first computing device; and
implementing each of the one or more filter layers on a second, different computing device.

9. The method of claim 1, wherein training the adapted neural network using the training objective, based on the neural network output and the predetermined response, to increase the likelihood of the predetermined response comprises backpropagating gradients of the training objective, wherein training objective is dependent on a difference between the neural network output and the predetermined response.

10. The method of claim 1, wherein
the pre-trained generative neural network and the adapted neural network are each configured to process an input sequence of tokens to generate an output token to extend the input sequence; wherein
processing the training request in the data item using the adapted neural network comprises:
tokenizing the training request to generate a request token sequence that represents the training request as a sequence of tokens, and
processing the request token sequence using the adapted neural network obtain the neural network output comprising an output sequence of tokens.

11. The method of claim 10, wherein
each training example comprises the training request and a corresponding undesired response; the method further comprising:
tokenizing the undesired response to generate an undesired response token sequence that represents the undesired response as a sequence of tokens;
selecting the first k tokens of the undesired response token sequence to obtain the input sequence of tokens for the adapted neural network; wherein
processing the training request in the data item using the adapted neural network comprises processing the input sequence of tokens using the adapted neural network, to obtain the output sequence of tokens; and further comprising
training the adapted neural network using the training objective to increase a likelihood of obtain the output sequence of tokens including the predetermined response token sequence.

12. The method of claim 11, wherein
training the adapted neural network using the training objective to increase the likelihood of obtain the output sequence of tokens including the predetermined response token sequence comprises backpropagating gradients of the training objective,
wherein the training objective is dependent on a difference between the output sequence of tokens and a predetermined response token sequence that represents the predetermined response as a sequence of tokens.

13. The method of claim 11, comprising selecting k randomly from a range between 1 and a maximum k-value.

14. The method of claim 1, wherein aligning the output of the pre-trained generative neural network using the dataset of training examples comprises adapting the pre-trained generative neural network to mitigate a risk of harmful output; wherein the training examples comprise harmful examples; and wherein the predetermined response comprises a safe response.

15. The method of claim 1, comprising:
obtaining the pre-trained generative neural network;
adapting the pre-trained generative neural network to obtain the adapted neural network by, for one or more of the stacks of the pre-trained neural network layers in the pre-trained generative neural network, inserting the filter layer after the stack of pre-trained neural network layers by:
providing the output from the stack of pre-trained neural network layers to the filter layer input; and
providing the filter layer output to the next neural layer after the stack of pre-trained neural network layers in the pre-trained generative neural network, for the next neural layer to process together with the output from the stack of pre-trained neural network layers.

16. The method of claim 1, wherein the pre-trained generative neural network comprises a language model or vision language model neural network.

17. A system comprising:
one or more computers; and
one or more storage devices communicatively coupled to the one or more computers, wherein the one or more storage devices store instructions that, when executed by the one or more computers, cause the one or more computers to perform operations comprising:
obtaining an adapted neural network, the adapted neural network comprising a pre-trained generative neural network and one or more filter layers, wherein
the pre-trained generative neural network comprises a plurality of pre-trained neural network layers each having a plurality of pre-trained trainable parameters;
each filter layer is configured to process a filter layer input comprising an output from a stack of the pre-trained neural network layers, in accordance with trainable parameters of the filter layer, to generate a filter layer output, and wherein a next neural network layer after the stack of pre-trained neural network layers is configured to process at least the filter layer output;
obtaining a training dataset comprising training examples, each training example comprising a training request, each training request having a predetermined response that indicates refusal of the request; and,
for a plurality of the training examples:
processing the training request in the training example, using the adapted neural network, to obtain a neural network output; and
training the adapted neural network using a training objective, based on the neural network output and the predetermined response, to increase a likelihood of the predetermined response; wherein
training the adapted neural network comprises adjusting the trainable parameters of the one or more filter layers whilst keeping the pre-trained trainable parameters of the pre-trained neural network layers fixed.

18. One or more non-transitory computer storage media storing instructions that when executed by one or more computers cause the one or more computers to perform operations
obtaining an adapted neural network, the adapted neural network comprising a pre-trained generative neural network and one or more filter layers, wherein
the pre-trained generative neural network comprises a plurality of pre-trained neural network layers each having a plurality of pre-trained trainable parameters;
each filter layer is configured to process a filter layer input comprising an output from a stack of the pre-trained neural network layers, in accordance with trainable parameters of the filter layer, to generate a filter layer output, and wherein a next neural network layer after the stack of pre-trained neural network layers is configured to process at least the filter layer output;
obtaining a training dataset comprising training examples, each training example comprising a training request, each training request having a predetermined response that indicates refusal of the request; and,
for a plurality of the training examples:
processing the training request in the training example, using the adapted neural network, to obtain a neural network output; and
training the adapted neural network using a training objective, based on the neural network output and the predetermined response, to increase a likelihood of the predetermined response; wherein
training the adapted neural network comprises adjusting the trainable parameters of the one or more filter layers whilst keeping the pre-trained trainable parameters of the pre-trained neural network layers fixed.

19. The one or more non-transitory computer storage media of claim 18, wherein the adapted neural network has been obtained from the pre-trained generative neural network by, for a plurality of stacks of the pre-trained neural network layers in a succession of stacks of the pre-trained neural network layers in the pre-trained generative neural network:
inserting a filter layer after each respective stack of pre-trained neural network layers, wherein:
each of the filter layers is configured to process the output from the respective stack of pre-trained neural network layers to generate the filter layer output, and
the next neural layer after the respective stack of pre-trained neural network layers is configured to process at least the filter layer output.

20. The one or more non-transitory computer storage media of claim 18, wherein the next neural layer after the stack of pre-trained neural network layers is configured to process a combination of the filter layer output and the output from the stack of pre-trained neural network layers; and
processing the training request in the training example, using the adapted neural network, to obtain the neural network output comprises:
processing the filter layer input using the filter layer to generate a filter layer weight; and
determining a weighted combination of the filter layer output and the output from the stack of pre-trained neural network layers in accordance with the filter layer weight; and
processing the weighted combination using the next neural layer after the stack of pre-trained neural network layers.
